(19) United States
(12) Patent Application Publication
(10) Pub. No.: US 2017/0082478 A1
(43) Pub. Date: Mar. 23, 2017

(54) SYSTEM AND METHOD OF ULTRASOUND LIQUID LEVEL DETECTION

(71) Applicant: Gems Sensors, Inc., Plainville, CT (US)

(72) Inventors: Bryan M. LaBarge, Wolcott, CT (US); James B. Dockendorff, North Haven, CT (US)

(21) Appl. No.: 15/263,928

(22) Filed: Sep. 13, 2016

Related U.S. Application Data
(60) Provisional application No. 62/221,620, filed on Sep. 22, 2015.

(51) Int. Cl. G01F 23/296; G01N 29/032

(52) U.S. Cl. CPC G01F 23/2961; G01N 29/032; G01F 23/2965; G01N 2291/022

(57) ABSTRACT

A liquid detection system for determining a presence of a liquid, including a piezoelectric element that outputs a first ultrasonic signal in response to an input electrical signal, and a housing with a first surface and a second surface disposed on opposite sides of a portion of the housing, a third surface disposed opposite the second surface across a gap in the housing, and a fourth surface and a fifth surface extending between the second surface and the third surface. The piezoelectric element is coupled to the first surface of the housing so that the piezoelectric element directs the first ultrasonic signal toward the second surface, and the gap in the housing is in fluid communication with a surrounding environment so that when fluid from the surrounding environment is present in the gap, the third surface of the housing reflects a second ultrasonic signal in response to the first ultrasonic signal when the liquid is present in the gap.

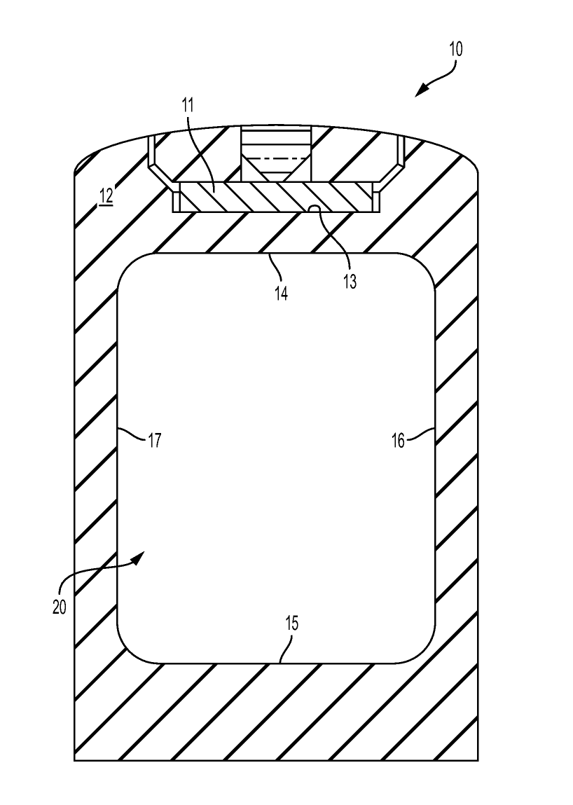

### CLAIM OF PRIORITY

This application claims priority to U.S. Provisional Patent Application No. 62/221,620, filed Sep. 22, 2015, the entire disclosure of which is incorporated by reference herein.

### FIELD OF THE INVENTION

The present disclosure relates generally to level indicators and, more particularly, to an improved ultrasonic liquid level detection system.

### BACKGROUND

Ultrasonic switches typically use inaudible high-frequency sound (ultrasound) to detect the presence (or lack thereof) of a liquid at a predetermined point. Generally such devices include an electronic control unit and a sensor. Liquid level is detected by the ultrasonic level switches using the physical properties of sound transmission in vapor and liquids. In particular, sound that travels in air loses a significant amount of its signal strength. However, the same sound when traveling in liquid retains almost all of its signal strength.

Known liquid level detection system generally require two piezoelectric crystals, where each crystal is mounted on one side of a gap in a sensor. The first crystal transmits sound and the second crystal receives sound. To detect liquid level, it must first be determined whether liquid or gas (air) is present in the gap. As described above, if liquid is present, a relatively high signal strength sound is received at the detection side. If gas is present, only a small amount of sound is received. The electronics used for processing the signals are configured to detect the difference in sound/signal level and respond accordingly.

Unfortunately, a significant limitation in the systems described is the requirement of dual piezoelectric crystals or piezoceramic elements to transmit and receive ultrasonic energy across a specified distance. Such a configuration results in a more complex and expensive device to make and sell. There have been attempts at using only a single crystal configuration. For example, U.S. Pat. No. 5,808,200 describes a method of reflecting ultrasound energy using one crystal.

The present invention recognizes and addresses considerations of prior art constructions and methods.

### SUMMARY

One embodiment of a liquid detection system for determining a presence of a liquid includes a piezoelectric element that outputs a first ultrasonic signal in response to an input electrical signal, and a housing with a first surface and a second surface disposed on opposite sides of a portion of the housing, a third surface disposed opposite the second surface across a gap in the housing, and a fourth surface and a fifth surface extending between the second surface and the third surface. The piezoelectric element is coupled to the first surface of the housing so that the piezoelectric element directs the first ultrasonic signal toward the second surface, and the gap in the housing is in fluid communication with a surrounding environment so that when fluid from the surrounding environment is present in the gap, the third surface of the housing reflects a second ultrasonic signal in response to the first ultrasonic signal when the liquid is present in the gap.

The accompanying drawings, which are incorporated in and constitute a part of this specification, illustrate one or more embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended drawing, in which:

The drawing is a partial cross-sectional view of liquid detection system in accordance with an embodiment of the present disclosure.

Repeat use of reference characters in the present specification and drawing is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

In order to provide an improved liquid level detection system and to overcome the disadvantages and problems of currently available devices, there is provided an ultrasonic liquid level detection system configured such that the gap between reflecting surfaces enables the ultrasound energy to be reflected across a wet gap instead of a dry gap. In other words, the gap is bridged by a liquid to allow the ultrasound energy to be transmitted and reflected between the two reflecting surfaces. In an exemplary embodiment, the reflection surfaces are parallel to each other. Advantageously, the distance between the surfaces does not need to be of any certain fixed distance. A particular benefit of the presently described system is the significantly reduced cost and labor of assembly. Still another advantage is the increased ruggedness and resistance to damage from being dropped or otherwise impacted.

Turning now to the drawing, an exemplary embodiment of a liquid detection system 10 is shown in greater detail. The system includes a piezoelectric element 11 placed inside a housing 12. The piezoelectric element 11 and the housing 12 are placed in contact with each other along a flat first surface 13. The piezoelectric element 11 and the housing 12 are coupled acoustically to each other with an interstitial material. The housing 12 includes several surfaces 13, 14, 15, 16 and 17.

The piezoelectric element 11 produces ultrasonic energy when an electric field acts upon it, which is directed from the first surface 13 to a second surface 14. The first surface 13 is parallel to the second surface 14. The ultrasound energy then passes through a gap 20 between the second surface 14 and the third surface 15 only if the gap 20 between them contains liquid and the liquid bridges the gap 20 completely between the second surface 14 and the third surface 15. If the gap 20 between the second surface 14 and the third surface 15 contains any air, the ultrasound energy is not reflected by the third surface 15. If liquid is bridging the second surface 14 and the third surface 15, the ultrasound energy is reflected off the third surface 15 and sent back towards to the second surface 14.

In this particular embodiment, the second surface 14 and the third surface 15 are parallel to each other. Once the ultrasound energy reaches the second surface 14, it is directed towards the first surface 13 and reaches the piezoelectric element 11. When the ultrasound energy interacts with the piezoelectric element 11, the piezoelectric element 11 converts the ultrasound energy back into electrical energy that can be used by an outside electronics processor. Note that the fourth surface 16 and fifth surface 17 are used as supports connecting the second surface 14 and the third surface 15. These surfaces do not have to be parallel to each other, but they cannot interfere with the ultrasound energy passing back and forth from the second and third surfaces. The presence of ultrasound energy (or the lack thereof) is thus the detection mechanism processed by the outside electronics processor.

It should be noted that manufacturing the housing or the structural embodiment containing the parallel surfaces may be made from a single piece or multiple pieces. An advantage of making the housing as one piece, as opposed to multiple pieces, eliminates or reduces any assembly and labor costs. Cost savings are also realized by not having to purchase the second part. Structurally, from a performance perspective, the one piece design eliminates any misalignment between the parallel surfaces that may occur when assembling multiple pieces together. As the surfaces approach parallelism, there is more acoustic (and thus electronic) signal amplitude for electronics to process. This translates to a more reliable sensor since it is much easier for an electronic circuit to detect higher voltages than low voltages.

Variations and alternate embodiments of the new and novel system described herein are possible. For example, the distance between the second surface 14 and the third surface 15 may be fixed, but the value of the distance is not required to be a specific value.

Another variation is that the second surface 14 and third surface 15 are not required to be included as part of the housing 12. If the third surface 15 is not part of the housing 12, then the second surface 14 and the third surface 15 must be parallel to the other.

A further variation of the innovation allows that any variation in distance between the second surface 14 and the third surface 15 could be a detectable occurrence by measuring the time between the initial signal creation by the piezoelectric element 10 and the return signal reflected by the third surface 15.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed:

1. A liquid detection system for determining a presence of a liquid, comprising:
a piezoelectric element that outputs a first ultrasonic signal in response to an input electrical signal; and
a housing with a first surface and a second surface disposed on opposite sides of a portion of the housing, a third surface disposed opposite the second surface across a gap in the housing, and a fourth surface and a fifth surface extending between the second surface and the third surface;
wherein the piezoelectric element is coupled to the first surface of the housing so that the piezoelectric element directs the first ultrasonic signal toward the second surface, and
wherein the gap in the housing is in fluid communication with a surrounding environment so that when fluid from the surrounding environment is present in the gap, the third surface of the housing reflects a second ultrasonic signal in response to the first ultrasonic signal when the liquid is present in the gap.

2. The liquid detection system of claim 1, wherein the fourth surface and the fifth surface constitute supports connecting the second surface and the third surface of the housing.

3. The liquid detection system of claim 1, wherein the first surface and the second surface are parallel to each other.

4. The liquid detection system of claim 1, wherein the third surface is parallel to the second surface of the housing.

5. The liquid detection system of claim 1, wherein the fourth surface and the fifth surface are parallel to each other.

6. The liquid detection system of claim 1, wherein the piezoelectric element is disposed inside the housing.
